(19) United States
(12) Patent Application Publication
(10) Pub. No.: US 2005/0188056 A1
(43) Pub. Date: Aug. 25, 2005

(54) Terminal based device profile web service

(75) Inventors: Jouni Kangas, Espoo (FI); Martti Lindroos, Oulu (FI)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(73) Assignee: Nokia Corporation, Espoo (FI)

(21) Appl. No.: 10/775,833

(22) Filed: Feb. 10, 2004

(51) Int. Cl. G06F 15/16

(52) U.S. Cl. 709/218

(57) ABSTRACT

A method and device are disclosed for reporting capability of a mobile device, in order to improve experiences of the user of the mobile device. This capability reporting is accomplished by a web service that makes available a device profile from a device profile repository located within the mobile device. The web service utilizes reverse hypertext transfer protocol (HTTP) binding for simple object access protocol (SOAP). Enhanced content is subsequently received at the mobile device, such as content in an improved format, and the enhanced content is based at least partly upon the capability of the mobile device disclosed by the web service. If a characteristic of the mobile device changes, thereby causing a modification of the capability of the mobile device for accepting a type of enhanced content, an update signal is sent to the device profile. The device profile is a user agent profile or variation thereof.

### TECHNICAL FIELD OF THE INVENTION

The invention relates to the device profile of a mobile device, for providing device capability information. Device capability information is essential for service applications to be able to provide optimal content by formatting or selecting content destined for a mobile device, and is also useful for other decisions about how to provide the best user experience based upon capabilities of the mobile device.

### BACKGROUND ART

Different mobile devices have different capabilities. Additionally, an owner or user of a mobile device can change the device's capabilities by, for example, installing or removing software, or by other means such as changing usage, situation, environment, or context of use. These differences between mobile devices, and differences in a single mobile device at separate times, are important for service providers to know about.

It is advantageous for service providers to be aware of the different capabilities of each mobile device, so that the service providers can adapt, modify, or make decisions for better user experiences based upon the current respective capabilities of the mobile devices. In other words, the different capabilities of mobile devices cannot be fully exploited unless service providers are aware about those diverse capabilities.

The capabilities of a mobile device include both hardware and software characteristics of the device, and may also include information about the network to which the device is connected. In contrast to device capabilities, user preferences would be important for content selection purposes based on the user's interests; for example a user preference can indicate that the user is interested in receiving sports scores. User preferences are not necessarily within the scope of the present invention, except to the extent that such user preference device settings (e.g. screen resolution, number of colours, additional appliances plugged in, default browser, mobile device profile in use) could have an impact on how the content is rendered, and could have importance for the service provider, can be regarded as part of the invention.

A serious problem with current mobile telecommunications systems is that application servers in the end-to-end (E2E) architecture cannot efficiently retrieve the necessary current device capability profile information of a mobile device. The Open Mobile Alliance (OMA) has developed a user agent profile (UAProf) for this purpose. The UAProf specification describes a mechanism to deliver a reference (URL) pointing to the external static device profile, and a mechanism (Profile-diff) to deliver the changes. This requires an external device profile repository for a static device profile, and additionally the mobile device must deliver information about all the changes. See, for example, “OMA-WAP-UAProf-v1_{—}1-20021212-c, User Agent Profile 1.1, Candidate Version 12-December-2002,” sections 11.1 and 11.2.

The existing OMA approach typically requires a device profile repository, which is a server for storing static device profiles for one or more mobile devices. Usually, the device profile repository would be a hypertext transfer protocol (HTTP) server. If a dynamic device profile repository is located separately from the mobile device, then the mobile device should regularly send updates to that dynamic device profile repository. Maintaining separate device profile repositories requires a maintenance process, even for static device profiles. Intermediate servers (gateways, proxies) can always cache the device profiles for further use, but that information is not necessarily up-to-date, and the profile information cached may not even be needed at the time it is sent to the intermediate servers.

FIG. 1 illustrates a typical prior art user agent profile end-to-end system 100. A mobile device 102 delivers a reference by sending a URL (which points to the static device profile) to a server 103 which is in contact 109 with a static device profile repository 110 that hosts the static device profile of the mobile device 102. The reference to the static device profile and possibly also the dynamic changes may be sent to the server 103 various different ways: directly in an HTTP request 106, or in an HTTP request 107 via an HTTP proxy 104, or in a first stage request 108 and a different second stage request 114 via a wireless application protocol (WAP) gateway.

Subsequently, the content server 103 establishes contact 109 with the device profile repository 110 in order to fetch the static device profile of the mobile device, and then the content server 103 merges the static device profile and the dynamic changes delivered by the mobile device in order to make decisions based on the merged device profile information, for example formatting content according to the device capabilities and sending 111 the optimal content to the mobile device 102.

A specification has been developed for enabling a mobile device to expose web services hosted by the mobile device to an HTTP server (e.g. to a content server 103). That specification employs a Simple Object Access Protocol (SOAP), and that specification is called Reverse HTTP Binding for SOAP. The informal abbreviation for that specification is “PAOS” (which is “SOAP” spelled backward). See “Liberty Reverse HTTP Binding for SOAP Specification,” Liberty Alliance Project, Version 1.0 (2003) incorporated herein by reference; “Liberty Identity Personal Profile Service Specification,” Liberty Alliance Project, Version 1.0-23 (2003). The PAOS concept was originally designed with the user profile information (rather than device profile information) in mind, for exposing a personal profile service rather than exposing an equipment or user agent profile. However, it is pointed out below that the usage of PAOS can be expanded to provide information about any services hosted by a mobile device.

### DISCLOSURE OF THE INVENTION

The present invention is for offering access to current and up-to-date capabilities of a mobile device, particularly the dynamically changing capabilities of the mobile device. The present invention can be expanded to include also static device profile information. The range of attributes (static and/or dynamic) depends on what the device profile implementation in the mobile device includes. When a characteristic of the mobile device changes, for example causing a modification of the capability of the mobile device for accepting a type of content format, that modification is updated in a data storage located within the mobile device. An update signal within the mobile device indicates this capability modification. The updated user agent profile is then available upon request from a device profile repository located within the mobile device, as a web service enabling a service application in an application server to make decisions based upon the device capabilities, for example to facilitate content formatting by the application server.

The device profile repository containing the user agent profile is situated within the mobile device. The web service is hosted and offered by the mobile device via reverse hypertext transfer protocol (HTTP) binding for SOAP. This PAOS-enabled mobile device can offer services and respond to queries contained in the HTTP responses from the server, without need for the mobile device to host an HTTP server.

The present invention is based on the idea of providing the device profile from the mobile device as a web service, and also upon the realization that the device profile repository containing the user agent profile can be effectively relocated into the mobile device itself. However, the mobile device hosting the device profile repository need not be an HTTP server.

The present invention enables application servers to retrieve the necessary and up-to-date dynamic device profile information from a mobile device in an efficient manner. This is accomplished by providing a mechanism to query that information directly from the mobile device, without the mobile device needing to host an HTTP server, and without the mobile device needing to deliver profile changes that may not even be immediately needed.

The present invention is therefore an improvement to the Open Mobile Alliance approach. Instead of requiring the dynamic capability profile of a mobile device to be routinely sent to the application server or, if a server for a dynamic device profile information exists, updated from a mobile device to a separate fixed device profile repository, the profile of the present invention resides at the mobile terminal where it will be responsive to profile requests. Instead of having the mobile device deliver all changes in the user agent profile, a mobile device directly offers the device profile as a web service, even though the mobile device does not require an HTTP server.

The mobile device of the present invention dynamically registers capability changes of the mobile device capabilities. The mobile device includes a processing unit (e.g. a central processing unit) that is responsive to changes in characteristics of the mobile device that cause modifications of the device's capability to, for example, accept a new type of content format. The processing unit is configured for sending an update signal, indicative of the modification, to a device profile repository within the mobile device. The device profile repository is responsive to the update signal from the processing unit, and the device profile repository stores an updated user agent profile which is thereafter made available to the processing unit. The processing unit is also responsive to a profile inquiry signal from a content server located outside the mobile device, and the processing unit provides a user agent profile signal to the content server, as a web service, to facilitate processes such as content formatting.

Mobile devices need to support several transport and application layer protocols, and some of the application layer protocols may already include a negotiation mechanism between a mobile device and a server. The present invention concentrates on providing a way in which HTTP servers can query the mobile device profile information directly from the mobile device with an HTTP client.

The present method and device improve experiences of the user of the mobile device. The web service makes available a device profile from a device profile repository located within the mobile device. The web service utilizes reverse hypertext transfer protocol (HTTP) binding for simple object access protocol (SOAP). Enhanced content is subsequently received at the mobile device, such as content in an improved format, and the enhanced content is based at least partly upon the capability of the mobile device disclosed by the web service. If a characteristic of the mobile device changes, thereby causing a modification of the capability of the mobile device for accepting a type of enhanced content (e.g. a type of formatting), then an update signal is sent to the device profile. The device profile may comprise a user agent profile.

### BRIEF DESCRIPTION OF THE DRAWINGS

FIG. 1 shows a prior art user agent profile end-to-end structure, with the device profile repository being external to the mobile device.

FIG. 2 shows a system and mobile device according to the present invention, using a block diagram.

FIG. 3 is a flow chart showing a method according to the present invention.

### DETAILED DESCRIPTION OF THE INVENTION

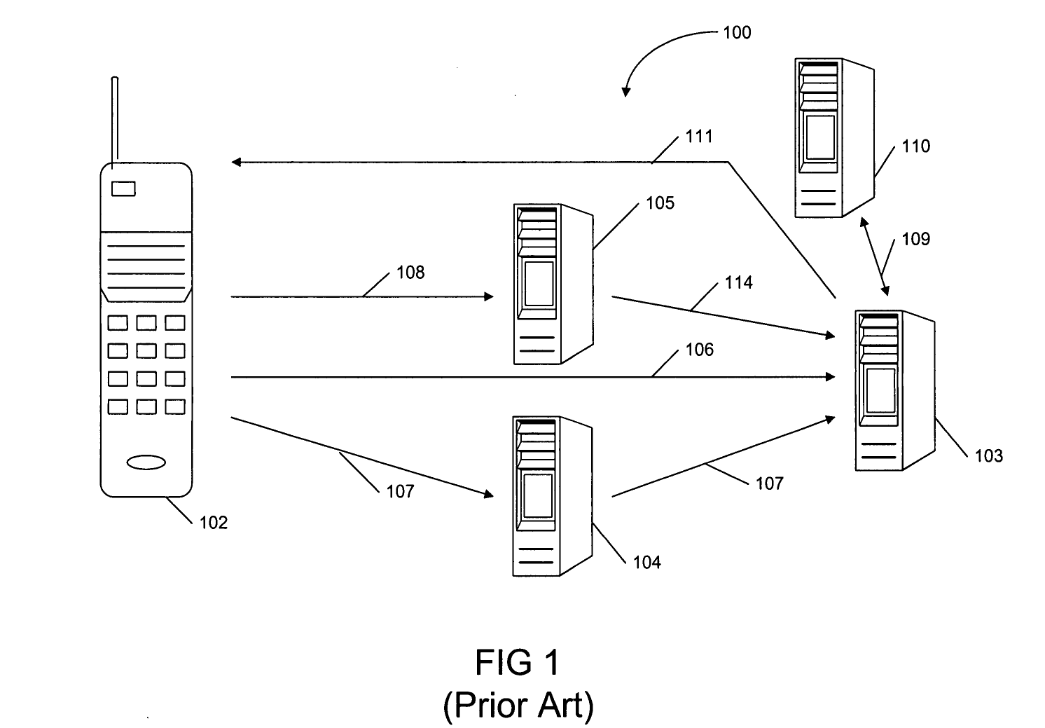

FIG. 1 shows a prior art device profile repository 110 external to the mobile device 102. According to that prior art end-to-end architecture shown in FIG. 1, the signals 106, 107, 108, and/or 114 are used to send the reference (URL) pointing to the static device profile in the profile repository 110, and are also possibly used to send the dynamic changes to the intermediate servers 105 and 104 and finally to the content server 103. This architecture is greatly simplified by the present claimed invention, in which the device profile repository 110 is effectively located in the interior of the mobile device 102.

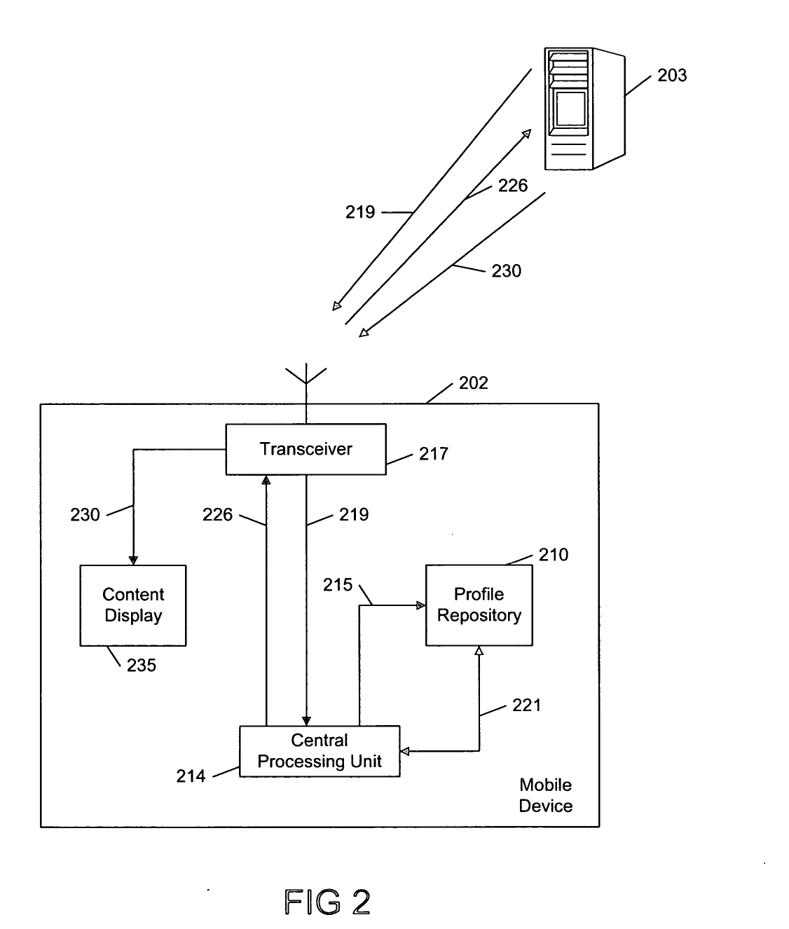

As seen in FIG. 2, the profile repository 210 is located inside the mobile device 202. This system shown in FIG. 2 shows an embodiment of the present invention which is able to accomplish the results similar to those of the prior art, but much more efficiently. Both systems report and utilize dynamic capability of a mobile device. However, according to the present invention, it is now possible for the mobile device 202 to include the device profile repository 210. The mobile device is therefore able to provide a user agent profile signal 226 as a web service, in order to facilitate processes such as content formatting. In this embodiment, the content server 203 is responsive to the user agent profile signal 226, and provides content 230 that is formatted according to the dynamic capability of the mobile device. The content is then presentable via a content display 235 which may be a display screen or speaker.

The mobile device 202 is able to accommodate the profile repository 210. The web service is offered to the content server 203 by reverse hypertext transfer protocol (HTTP) binding for simple object access protocol (SOAP). Instead of requiring an HTTP server in the mobile device to provide this web service, the mobile device needs to have subsystems to handle the query protocol. The reverse HTTP binding for SOAP (i.e. PAOS) is critical to informing the content server 203 that the mobile device 202 is hosting and offering a device profile web service. The device profile repository 210 has effectively been reduced in this embodiment of the present invention to a memory module, instead of a server.

Included in the mobile device 202 is a processing unit 214, which is responsive to a change in at least one characteristic of the mobile device that causes a modification of the device's capability to, for example, accept a type of content format. The processing unit 214 is configured for then sending an update signal 215 indicative of that modification, to the profile repository. The device profile repository 210, responsive to the update signal, stores an updated user agent profile, and makes the user agent profile available to the processing unit 214 via ask and answer signals 221.

The processing unit 214 is furthermore responsive to a profile inquiry signal 219 originating at the content server 203, and is also for providing a user agent profile signal 226, indicative of at least a portion of the user agent profile. This user agent profile signal 226 is provided as a web service to, for example, facilitate content formatting at the content server 203.

The mobile device 202 is equipped with a transceiver for transmitting the user agent profile signal 226 as a SOAP response message inside a request, the user agent profile signal 226 being in response to the profile inquiry signal 219 which is a received SOAP signal asking for at least part of the user agent profile. The web service is provided by the user agent profile signal 226 as a reverse hypertext transfer protocol (HTTP) binding for SOAP. Of course, the content signal 230, the user agent profile signal 226, and the profile inquiry signal 219 all pass through the transceiver 217 by which the mobile device 202 communicates with the content server 203.

The characteristic of the mobile device that changes, and that thereby modifies the device's ability to, for example, accept types of content format, may be a hardware property of the mobile device (e.g. color capability, screen size, pixel aspect ratio, sound capability, and number of soft keys), a software property such as installed software and operating system (or content types and character sets), browser attributes (e.g. browser name, markup language version, markup language modules, frame and table support, javascript support), the network environment (e.g. session bearer, available bearers, and available security and encryption mechanisms), wireless application protocol or WAP environment (e.g. deck size, markup language version, markup language script libraries), or push capabilities (e.g. content types, application types, character sets, and message size).

It is to be understood that content format is a distinct concept from content selection, although the two related concepts can affect each other. Content formatting is for adapting selected content to the capability of the mobile device. The content formatting includes, for example, scaling a bitmap and adjusting a color map to fit a display, or using resampling to reduce an image size or a music file size.

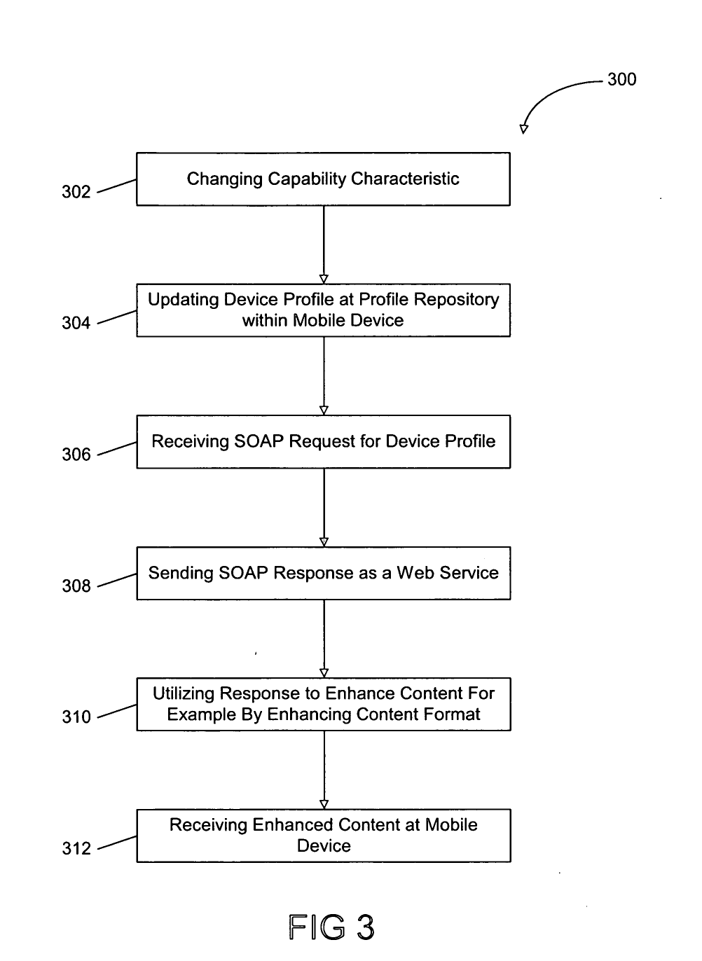

As seen in FIG. 3, the present invention includes a method 300 that begins by changing 302 some characteristic that alters the capabilities of a mobile device, followed by updating 304 a user agent profile at a device profile repository within the mobile device. Subsequently, a SOAP request is received 306 by the mobile device requesting at least part of the user agent profile. Then the mobile device sends 308 a SOAP response, as a web service, to the content server. The content server then utilizes 310 the SOAP response in order to optimize the content format, and the mobile device then receives 312 the enhanced content. Of course, there will undoubtedly be intervening steps in this method. For example, receiving 306 the SOAP request will often be prompted by an attempt by a mobile device to access a particular internet site. Likewise, receiving 306 the SOAP request and sending 308 the SOAP response will be separated by the step of accessing the device profile from the device profile repository within the mobile device. This method will be performed at least partly by software installed in a processing unit in a mobile device, the software being implemented as a data structure embodied in a computer readable medium located in the mobile device.

It is to be understood that all of the present Figures, and the accompanying narrative discussions, do not purport to be completely rigorous treatments of the method, device, and system under consideration. A person skilled in the art will understand that the steps and signals of the present application represent general cause-and-effect relationships that do not exclude intermediate interactions of various types, and will further understand that the various steps and structures described in this application can be implemented by a variety of different combinations of hardware and software, in a variety of different arrangements and sequences, all of which need not be further detailed herein.

1. A method of reporting capability of a mobile device in order to improve a user experience, comprising:
offering a web service that makes available a device profile from a device profile repository located within the mobile device, using a reverse hypertext transfer protocol (HTTP) binding for simple object access protocol (SOAP), and
receiving enhanced content at the mobile device, the enhanced content being based at least partly upon the capability of the mobile device disclosed by the web service.

2. The method of claim 1, wherein the enhanced content comprises optimized content formatting, and wherein the mobile device is configured differently than an HTTP server.

3. The method of claim 1, further comprising the steps of:
changing at least one characteristic of the mobile device causing a modification of the capability of the mobile device for accepting at least one type of content format,
sending an update signal to the device profile located at the device profile repository within the mobile device, the update signal being indicative of the modification, and
providing at least a portion of the device profile from the device profile repository upon request, via the web service.

4. The method of claim 3, wherein providing the device profile from the device profile repository upon request includes:
receiving a profile inquiry signal from a server outside the mobile device, the profile inquiry signal being a simple object access protocol (SOAP) signal asking for at least part of the device profile; and
sending to the server a SOAP response message inside a request, the response message including the part of the device profile from the device profile repository,
wherein the web service is provided at least for content formatting, and
wherein the device profile comprises a user agent profile.

5. The method of claim 3, wherein the characteristic of the mobile device is a hardware feature, a software feature, or an environment feature.

6. The method of claim 2, wherein the content formatting is distinct from content selection, and wherein the content formatting is for adapting selected content to the capability of the mobile device.

7. The method of claim 1, wherein the device profile repository is a memory module instead of a server, and wherein the mobile device hosting the device profile repository is configured differently from an HTTP server.

8. The method of claim 4, wherein the server is an HTTP server, and wherein the request containing the SOAP response message is an HTTP request.

9. The method of claim 3, wherein providing at least a portion of the device profile is subsequently followed by utilizing the device profile to optimize the content format, and supplying the content in the content format to the mobile device.

10. The method of claim 9, wherein the utilizing and the supplying are performed by a content server located external to the mobile device.

11. The method of claim 2, wherein the content formatting includes scaling a bitmap and adjusting a color map to fit a display.

12. The method of claim 2, wherein the content formatting includes using resampling to reduce an image size or a music file size.

13. A data structure embodied in a computer readable medium, for performing the method of claim 1.

14. A mobile device for reporting capability in order to improve a user experience, comprising:
a device profile repository for making available a device profile;
a processing unit, responsive to at least part of the device profile made available by the profile repository, for providing a device profile signal, and
a transceiver, responsive to the device profile signal, for transmitting said device profile signal as a web service using reverse hypertext transfer protocol (HTTP) binding for simple object access protocol (SOAP),
wherein the transceiver is also for receiving enhanced content at the mobile device, the enhanced content being based at least partly upon the capability of the mobile device disclosed by the device profile signal.

15. The mobile device of claim 14, wherein the enhanced content comprises optimized content formatting, and wherein the mobile device is configured differently than an HTTP server.

16. The mobile device of claim 14,
wherein the processing unit is also responsive to a change in at least one characteristic of the mobile device that causes a modification of the capability to accept at least one type of content format, the processing unit being configured for sending an update signal indicative of the modification,
wherein the device profile repository is responsive to the update signal, and is for consequently storing an updated device profile in the device profile repository, and
wherein the processing unit is also responsive to a profile inquiry signal, and is for seeking the device profile from the profile repository.

17. The mobile device of claim 16,
wherein the transceiver is for transmitting the device profile signal as a SOAP response message inside a request, the device profile signal being a response to the profile inquiry signal that is a received SOAP signal.

18. The mobile device of claim 16, wherein the device profile comprises a user agent profile, and wherein the web service is used at least for content formatting.

19. The mobile device of claim 16, wherein the characteristic of the mobile device is a hardware feature, a software feature, or an environment feature.

20. The mobile device of claim 17, wherein the content formatting is distinct from content selection, and wherein the content formatting is for adapting selected content to the capability of the mobile device.

21. The mobile device of claim 16, wherein the device profile repository is a memory module instead of a server, and wherein the mobile device hosting the device profile repository is configured differently from an HTTP server.

22. The mobile device of claim 17, wherein the request containing the SOAP response message is an HTTP request.

23. The mobile device of claim 15, wherein the content formatting includes scaling a bitmap and adjusting a color map to fit a display.

24. The mobile device of claim 15, wherein the content formatting includes using resampling to reduce an image size or a music file size.

25. A system for reporting capability of a mobile device in order to improve a user experience, comprising:
a mobile device including a device profile repository, for providing a device profile signal as a web service, the device profile signal being indicative of the capability; and
a content server, responsive to the device profile signal, for providing enhanced content that is enhanced according to the capability of the mobile device.

26. The system of claim 25, wherein the web service is provided by reverse HTTP binding for SOAP, and wherein the capability is dynamic.
